(19) United States
(12) Patent Application Publication
(10) Pub. No.: US 2025/0353171 A1
(43) Pub. Date: Nov. 20, 2025

(54) CONSTRAINT MANAGEMENT

(71) Applicant: Honda Motor Co., Ltd., Tokyo (JP)

(72) Inventors: Keyvan MAJD, Ann Arbor, MI (US); Rana SOLTANI ZARRIN, Los Gatos, CA (US)

(21) Appl. No.: 18/978,864

(22) Filed: Dec. 12, 2024

Related U.S. Application Data
(60) Provisional application No. 63/648,001, filed on May 15, 2024.

(51) Int. Cl. B25J 9/16; G06F 9/48

(52) U.S. Cl. CPC B25J 9/1661; B25J 9/1694; G06F 9/485

(57) ABSTRACT

According to one aspect, constraint management may include determining a context associated with a current task and calculating one or more constraints associated with the current task based on the context and a set of constraints. The computer-implemented method for constraint management may include sensing an aspect of a physical environment using a sensor and determining the context associated with the current task based on the aspect of the physical environment.

### CROSS-REFERENCE TO RELATED APPLICATIONS

This application claims the benefit of U.S. Provisional Patent Application, Ser. No. 63/648,001 (Attorney Docket No. HRA-56048) entitled “CONTEXT-AWARE SAFETY SPECIFICATION”, filed on May 15, 2024; the entirety of the above-noted application(s) is incorporated by reference herein.

### BACKGROUND

Robots have long been fixtures in many technological fields, but sweeping advances in technology over the last two decades have given robotics a platform and presence across all sectors that has changed the landscape of the workplace forever, bolstering productivity in a way that was previously unimaginable and certainly unattainable. With such a swift move to center stage, workplace robots have notoriously been met with apprehension, hesitation, and even insecurity, as the pace of their introduction and evolution threatened to outrun safety standard updates and employees feared job displacement.

### BRIEF DESCRIPTION

According to one aspect, a system for constraint management may include a processor and a memory. The memory may store one or more instructions. The processor may execute one or more of the instructions stored on the memory to perform one or more acts, actions, and/or steps. For example, the processor may perform determining a context associated with a current task and calculating one or more constraints associated with the current task based on the context and a set of constraints.

The system for constraint management may include a sensor sensing an aspect of a physical environment. The sensor may be an image capture device, a force sensor, an acceleration sensor, a pressure sensor, or a proximity sensor. The processor may determine the context associated with the current task based on the aspect of the physical environment. The current task may be a sub-task of one or more sub-tasks for a long-horizon task. The context may be a type of task associated with the current task. A constraint of the one or more constraints may be a force constraint, an interaction force constraint, a velocity constraint, an acceleration constraint, a proximity constraint, a positional constraint, or a trajectory constraint.

The system for constraint management may include a sensor sensing feedback from a human. The processor may determine one or more additional constraints associated with the current task based on the feedback from the human. The sensor may be an input device, a microphone, a keyboard, or a touchscreen. The processor may determine the one or more additional constraints associated with the current task based on a large language model (LLM). The system for constraint management may include a robot appendage and an actuator implementing the current task in accordance with the one or more constraints.

According to one aspect, a computer-implemented method for constraint management may include determining a context associated with a current task and calculating one or more constraints associated with the current task based on the context and a set of constraints. The computer-implemented method for constraint management may include sensing an aspect of a physical environment using a sensor and determining the context associated with the current task based on the aspect of the physical environment.

The sensor may be an image capture device, a force sensor, an acceleration sensor, a pressure sensor, or a proximity sensor. The current task may be a sub-task of one or more sub-tasks for a long-horizon task. The context may be a type of task associated with the current task.

According to one aspect, a constraint efficient robot may include a memory, a processor, a robot appendage, and an actuator. The memory may store one or more instructions. The processor may execute one or more of the instructions stored on the memory to perform one or more acts, actions, and/or steps. For example, the processor may perform determining a context associated with a current task and calculating one or more constraints associated with the current task based on the context and a set of constraints. The robot appendage and the actuator may implement the current task in accordance with the one or more constraints.

The constraint efficient robot may include a sensor sensing an aspect of a physical environment. The processor may determine the context associated with the current task based on the aspect of the physical environment. The sensor may be an image capture device, a force sensor, an acceleration sensor, a pressure sensor, or a proximity sensor. The current task may be a sub-task of one or more sub-tasks for a long-horizon task. The context may be a type of task associated with the current task.

### BRIEF DESCRIPTION OF THE DRAWINGS

FIG. 1 is an exemplary component diagram of a system for constraint management, according to one aspect.

FIG. 2 is an exemplary flow diagram of a computer-implemented method for constraint management, according to one aspect.

FIG. 3 is an exemplary scenario where the system for constraint management may be implemented, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

Dexterous robot appendages should be able to perform long-horizon manipulation tasks that include multiple sub-tasks. Different sub-tasks may be associated with different constraints that are more pertinent than other constraints. For example, when there is no interaction force, interaction force constraints may be deactivated.

According to one aspect, for a physical human robot interaction (pHRI), it is not necessary to optimize control actions subject to all constraints at each iteration, as this may be computationally expensive. Again, when there is no interaction force, interaction force constraints may be deactivated. In this way, context-aware safety constraints may be generated to improve real-time solution speed and improve the feasibility of constraints with similar or lower priority than the deactivated constraint. As described herein, a long-horizon task may include two or more sub-tasks, such as reaching for the object, grasping the object, or reorienting the object after the object is grasped, etc. However, other sub-tasks are contemplated. In any event, any number of sub-tasks may form the task together (e.g., the long-horizon task).

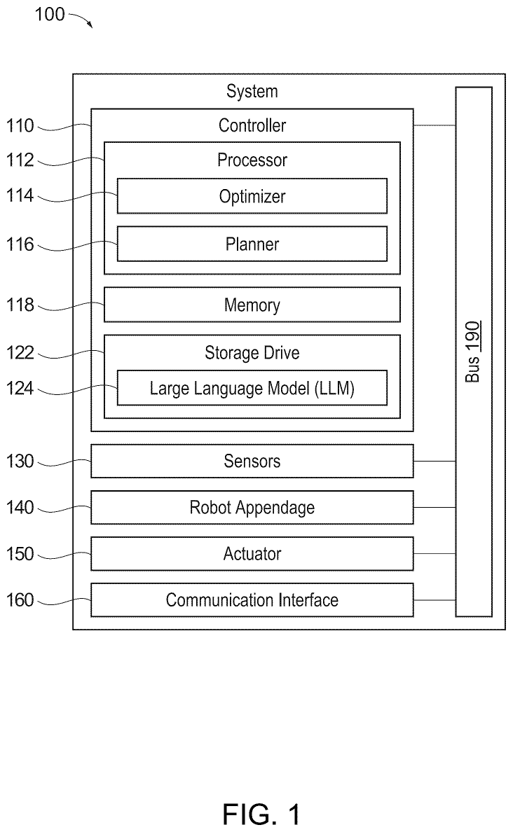

FIG. 1 is an exemplary component diagram of a system 100 for constraint management, according to one aspect. The system 100 for constraint management may include a controller 110. The controller 110 may include a processor 112. The processor 112 may include an optimizer 114 and a planner 116. The controller 110 may include a memory 118 and a storage drive 122. The storage drive 122 may be utilized to store a model, such as a large language model (LLM) 124. The system 100 for constraint management may include one or more sensors 130, a robot appendage 140, one or more actuators 150, a communication interface 160, and a bus 190.

According to one aspect, the system 100 for constraint management may be implemented on a robot. According to another aspect, the system 100 for constraint management may be a robot for constraint management or a constraint efficient robot. In any event, the bus 190 may communicatively couple or operably couple respective components of the system 100 for constraint management and enable computer communication therebetween. The memory 118 may store one or more instructions. The processor 112 may execute one or more of the instructions stored on the memory 118 to perform one or more acts, actions, and/or steps.

The sensor 130 may sense an aspect of a physical environment. The sensor 130 may be an image capture device capturing an image of the physical environment, a force sensor measuring a force associated with the system 100 for constraint management or the robot appendage 140, an acceleration sensor measuring an acceleration associated with the system 100 for constraint management or the robot appendage 140, a pressure sensor measuring a pressure associated with the system 100 for constraint management or the robot appendage 140, or a proximity sensor measuring a proximity of the system 100 for constraint management or the robot appendage 140 from an object, for example.

The planner 116 or the processor 112 may break down the long-horizon task into smaller sub-tasks. In other words, the planner 116 or the processor 112 may break down the long-horizon task into multiple sub-tasks (e.g., reaching for the object, grasping the objects, reorienting the object, etc.). While the sub-tasks are discussed in terms of these three sub-tasks, other sub-tasks are contemplated, and fewer or more sub-tasks may be included in the long-horizon task.

The processor 112 or the optimizer 114 may determine a context associated with a current task based on the current sub-task, a type of task associated with the current task, a type of task associated with the current sub-task, or the aspect of the physical environment sensed by the sensor 130, for example. The current task may be a sub-task of one or more sub-tasks for a long-horizon task. Thus, the context may be a type of task associated with the current task. For example, if the robot appendage 140 is not within proximity for interacting with an object or a human, no interaction force constraints need to be calculated. In this regard, sub-tasks which are associated with this scenario may be labelled or tagged accordingly.

In this way, the processor 112 or the optimizer 114 may calculate one or more constraints associated with the current task based on the context and a set of constraints (e.g., a set of all possible constraints). Examples of a constraint of the one or more constraints may include a force constraint, an interaction force constraint, a velocity constraint, an acceleration constraint, a proximity constraint, a positional constraint, or a trajectory constraint.

For example, different sub-tasks may be associated with different constraints that are more pertinent than other constraints. Explained another way, the processor 112 or the optimizer 114 may not calculate one or more constraints not associated with the current task. Stated yet again, the set of constraints may include a first set of constraints that are relevant to the current task or the current sub-task based on the context and a second set of constraints that are not relevant to the current task or the current sub-task based on the context. Using the context, the processor 112 or the optimizer 114 may optimize control actions, only as necessary, subject to any applicable constraints at each iteration. In this way, the processor 112 or the optimizer 114 may only solve for constraints which are relevant to a specific portion of the current task or the current sub-task.

For example, if the robot appendage 140 is not interacting with a human or an object for a current iteration, a current task, or a current sub-task, the processor 112 or the optimizer 114 may deactivate the interaction force constraint and eliminate performing any associated calculations for the interaction force constraint. Thus, context-aware safety constraints may be generated to improve real-time solution speed and improve the feasibility of constraints with similar or lower priority than the deactivated constraint.

The robot appendage 140 and the actuator 150 may implement the current task in accordance with the one or more constraints.

The communication interface 160 may include one or more sensors or input devices, such as a microphone, a keyboard, or a touchscreen. The communication interface 160 may sense or receive feedback from a human, such as a voice input, or a text input, an image capture of a facial expression, etc. According to one aspect, the communication interface 160 may provide prompts to the user to encourage the user to provide feedback. Using this input, the processor 112 may determine one or more additional constraints or modify bounds of existing constraints associated with the current task based on the feedback from the human. If a user indicates verbally that too much force is being applied from the robot appendage 140 to the human body, the bounds of existing constraints may be modified accordingly. In this way, constraints may be customized to each individual, for example.

According to one aspect, the processor 112 may determine the one or more additional constraints associated with the current task based on a large language model (LLM) 124 or a language guided model. For example, the LLM 124 may be utilized to perform spatio-temporal reasoning or constraint management in association with the additional constraints or the modified constraints. The processor 112 may utilize the LLM 124 to construct an abstract observation model of one or more states as inputs to the language model. Based on the observation model, the processor 112 may utilize the LLM 124 to reason about which states to bound and what should be the bound.

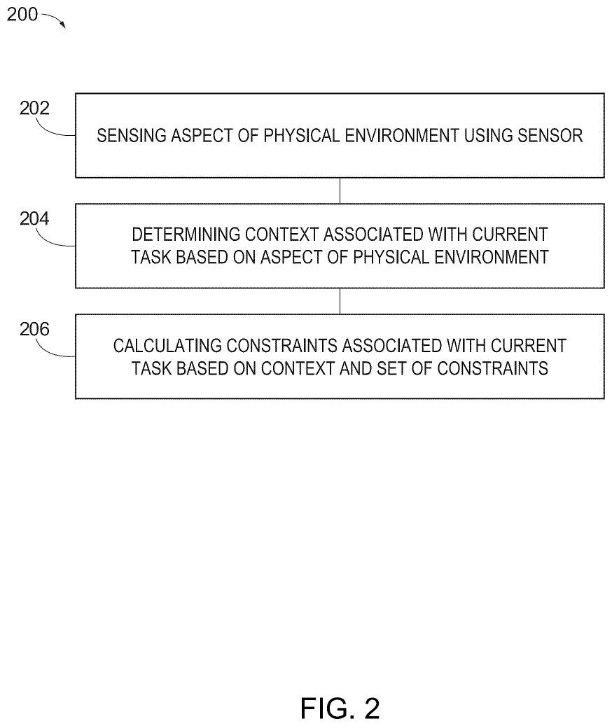

FIG. 2 is an exemplary flow diagram of a computer-implemented method 200 for constraint management, according to one aspect. The computer-implemented method 200 for constraint management may include sensing 202 an aspect of a physical environment using a sensor, determining 204 a context associated with a current task based on the aspect of the physical environment, and calculating 206 one or more constraints associated with the current task based on the context and a set of constraints.

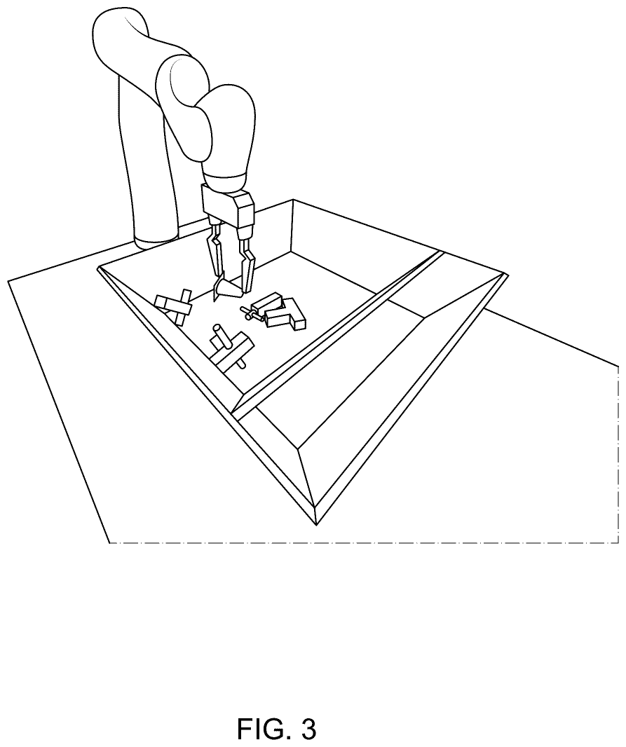

FIG. 3 is an exemplary scenario where the system for constraint management may be implemented, according to one aspect. In FIG. 3, a robot may be seen interacting with an object. When the robot is not interacting with the object, the interaction force calculation may be disabled, for example. Further, if the robot appendage is a threshold proximity away from all objects, acceleration and velocity constraints may be disabled, for example.

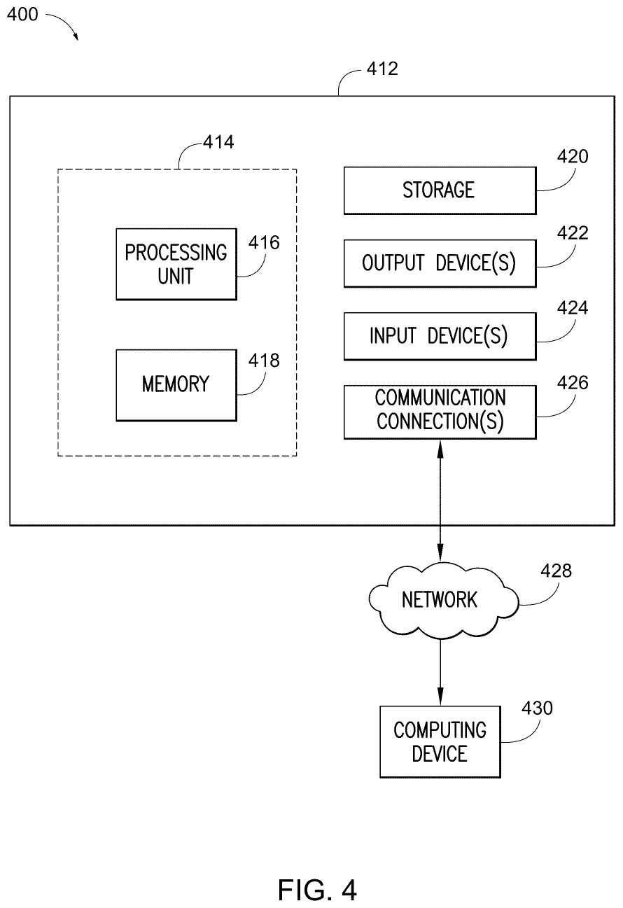

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

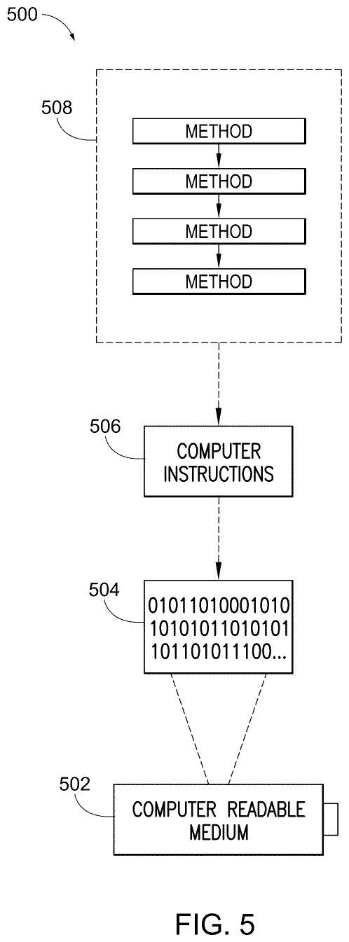

Still another aspect involves a computer-readable medium including processor-executable instructions configured to implement one aspect of the techniques presented herein. An aspect of a computer-readable medium or a computer-readable device devised in these ways is illustrated in FIG. 5, where an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 200 for constraint management of FIG. 2. In another aspect, the processor-executable computer instructions 506 may be configured to implement a system, such as the system 100 for constraint management of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for constraint management, comprising:
a memory storing one or more instructions; and
a processor executing one or more of the instructions stored on the memory to perform:
determining a context associated with a current task; and
calculating one or more constraints associated with the current task based on the context and a set of constraints.

2. The system for constraint management of claim 1, comprising a sensor sensing an aspect of a physical environment, wherein the processor determines the context associated with the current task based on the aspect of the physical environment.

3. The system for constraint management of claim 2, wherein the sensor is an image capture device, a force sensor, an acceleration sensor, a pressure sensor, or a proximity sensor.

4. The system for constraint management of claim 1, wherein the current task is a sub-task of one or more sub-tasks for a long-horizon task.

5. The system for constraint management of claim 1, wherein the context is a type of task associated with the current task.

6. The system for constraint management of claim 1, wherein a constraint of the one or more constraints is a force constraint, an interaction force constraint, a velocity constraint, an acceleration constraint, a proximity constraint, a positional constraint, or a trajectory constraint.

7. The system for constraint management of claim 1, comprising a sensor sensing feedback from a human, wherein the processor determines one or more additional constraints associated with the current task based on the feedback from the human.

8. The system for constraint management of claim 7, wherein the sensor is an input device, a microphone, a keyboard, or a touchscreen.

9. The system for constraint management of claim 7, wherein the processor determines the one or more additional constraints associated with the current task based on a large language model (LLM).

10. The system for constraint management of claim 1, comprising:
a robot appendage and an actuator implementing the current task in accordance with the one or more constraints.

11. A computer-implemented method for constraint management, comprising:
determining a context associated with a current task; and
calculating one or more constraints associated with the current task based on the context and a set of constraints.

12. The computer-implemented method for constraint management of claim 11, comprising:
sensing an aspect of a physical environment using a sensor; and
determining the context associated with the current task based on the aspect of the physical environment.

13. The computer-implemented method for constraint management of claim 12, wherein the sensor is an image capture device, a force sensor, an acceleration sensor, a pressure sensor, or a proximity sensor.

14. The computer-implemented method for constraint management of claim 11, wherein the current task is a sub-task of one or more sub-tasks for a long-horizon task.

15. The computer-implemented method for constraint management of claim 11, wherein the context is a type of task associated with the current task.

16. A constraint efficient robot, comprising:
a memory storing one or more instructions;
a processor executing one or more of the instructions stored on the memory to perform:
determining a context associated with a current task; and
calculating one or more constraints associated with the current task based on the context and a set of constraints; and
a robot appendage and an actuator implementing the current task in accordance with the one or more constraints.

17. The constraint efficient robot of claim 16, comprising a sensor sensing an aspect of a physical environment, wherein the processor determines the context associated with the current task based on the aspect of the physical environment.

18. The constraint efficient robot of claim 17, wherein the sensor is an image capture device, a force sensor, an acceleration sensor, a pressure sensor, or a proximity sensor.

19. The constraint efficient robot of claim 16, wherein the current task is a sub-task of one or more sub-tasks for a long-horizon task.

20. The constraint efficient robot of claim 16, wherein the context is a type of task associated with the current task.
